(19) United States
(12) Patent Application Publication
(10) Pub. No.: US 2026/0333218 A1
(43) Pub. Date: Oct. 22, 2026

(54) DETERMINING OPTIMAL MOBILE COMPUTING DEVICE FOR WIRELESS POWER TRANSFER USING A SUSTAINABILITY METRIC

(71) Applicant: International Business Machines Corporation, Armonk, NY (US)

(72) Inventor: Charan ACHARYA CHANDRASHEKAR, Bangalore (IN)

(21) Appl. No.: 19/180,445

(22) Filed: Apr. 16, 2025

(51) Int. Cl. H04W 52/02; H02J 50/40; H04L 41/0833

(52) U.S. Cl. CPC H04W 52/0212; H02J 50/40; H04L 41/0833

(57) ABSTRACT

In some implementations, a requesting computing device may transmit an energy transfer request. The requesting computing device may receive one or more acknowledgment messages from one or more mobile computing devices, each acknowledgment message being associated with a respective mobile computing device and including one or more respective operating characteristics about the respective mobile computing device. The requesting computing device may compute a respective sustainability metric for each mobile computing device of the one or more mobile computing devices using the one or more respective operating characteristics of each acknowledgment message. The requesting computing device may select an optimal mobile computing device from the one or more mobile computing devices by analyzing the respective sustainability metric for each mobile computing device of the one or more mobile computing devices. The requesting computing device may receive an energy transfer from the optimal mobile computing device through a wireless power transmission.

### BACKGROUND

This disclosure relates to wireless power transfer, and more specifically, to determining an optimal mobile computing device for wireless power transfer using a sustainability metric.

### SUMMARY

Some aspects described herein relate to a computer-implemented method. The method may include transmitting, by a requesting computing device, an energy transfer request. The method may include receiving, by the requesting computing device, one or more acknowledgment messages from one or more mobile computing devices, each respective acknowledgment message of the one or more acknowledgment messages being associated with a respective mobile computing device of the one or more mobile computing devices, the respective acknowledgment message including one or more respective operating characteristics of the respective mobile computing device. The method may include computing, by the requesting computing device, a respective sustainability metric for each mobile computing device of the one or more mobile computing devices using the one or more respective operating characteristics of each acknowledgment message. The method may include selecting, by the requesting computing device, an optimal mobile computing device from the one or more mobile computing devices by analyzing the respective sustainability metric for each mobile computing device of the one or more mobile computing devices. The method may include receiving, by the requesting computing device, an energy transfer from the optimal mobile computing device through a wireless power transmission.

Some aspects described herein relate to a computer system. The computer system may include a processor set, one or more computer-readable storage media, and program instructions stored on the one or more computer-readable storage media to cause the processor set to perform operations. The operations may include broadcasting an energy transfer request based at least in part on a trigger event. The operations may include receiving one or more acknowledgment messages to the energy transfer request, each respective acknowledgment message of the one or more acknowledgment messages including one or more respective operating characteristics of a respective mobile computing device. The operations may include selecting, to perform an energy transfer, an optimal mobile computing based at least in part on the one or more acknowledgment messages. The operations may include transmitting a selection indication that specifies the optimal mobile computing device is selected to perform the energy transfer. The operations may include receiving the energy transfer from the optimal mobile computing device through a wireless power transmission.

Some aspects described herein relate to a computer program product. The computer program product may include one or more computer-readable storage media and program instructions stored on the one or more computer-readable storage media to perform operations. The operations may include transmitting an energy transfer request to mobile computing devices. The operations may include receiving multiple acknowledgment messages from multiple mobile computing devices, each acknowledgment message being associated with a respective mobile computing device of the multiple mobile computing devices, each acknowledgment message including one or more operating characteristics about the respective mobile computing device. The operations may include computing, a respective sustainability metric for each mobile computing device of the multiple mobile computing devices using the one or more operating characteristics of the respective acknowledgment message. The operations may include transmitting a selection indication to one or more mobile computing devices of the multiple mobile computing devices based at least in part on the respective sustainability metric for each mobile computing device of the one or more mobile computing devices. The operations may include coordinating an energy transfer from one or more mobile computing devices.

Some aspects described herein relate to a computer program product. The computer program product may include one or more computer-readable storage media and program instructions stored on the one or more computer-readable storage media to perform operations. The operations may include receiving an energy transfer request from a requesting computing device. The operations may include transmitting an acknowledgment message to the requesting computing device, the acknowledgment message including one or more operating characteristics of the mobile computing device. The operations may include receiving a selection indication associated with the energy transfer request. The operations may include changing from a first location to a second location that is associated with the requesting computing device.

### BRIEF DESCRIPTION OF THE DRAWINGS

FIG. 1 is a diagram of an example computing environment for determining an optimal mobile computing device for wireless power transfer using a sustainability metric.

FIGS. 2A, 2B, 2C, and 2D are diagrams of a first example, a second example, a third example, and a fourth example, respectively, of communication exchanges that may be used by a requesting computing device to determine an optimal mobile computing device for wireless power transfer using a sustainability metric.

FIG. 3 is an example flow diagram for a process that may be used to determine an optimal mobile computing device for wireless power transfer using a sustainability metric.

FIG. 4 is a diagram of example components of a device associated with determining an optimal mobile computing device for wireless power transfer using a sustainability metric.

FIG. 5 is a flowchart of an example process associated with determining an optimal mobile computing device for wireless power transfer using a sustainability metric.

FIG. 6 is a flowchart of an example process associated with determining an optimal mobile computing device for wireless power transfer using a sustainability metric.

### DETAILED DESCRIPTION

The following detailed description of example implementations refers to the accompanying drawings. The same reference numbers in different drawings may identify the same or similar elements.

A moving server is a computing device that may operate in diverse and dynamic environments relative to a fixed server, such as locations where traditional infrastructure is unavailable or unreliable. The moving server may be mobile to enable deployment to various locations and may be used to support a wide range of applications, such as data collection and processing, communication services, and other computational tasks. The moving nature of a moving server may result in increased energy consumption (e.g., relative to a fixed server) and/or unpredictable energy consumption. To illustrate, the varying nature of the range of applications supported by a moving server may result in varying energy consumption that is based at least in part on a current application, a current location, and/or current computational tasks being performed by the moving server. Alternatively, or additionally, a moving server may remain operational for extended periods, in areas with reduced energy resources.

A moving server may receive energy at a remote location through wireless power transmission from a mobile energy source. To illustrate, the mobile energy source may be a mobile computing device that includes a capability to wirelessly transmit energy that may be received and stored by the moving server. However, energy management for a moving server may have environmental implications, such as increased carbon emissions that are associated with any combination of the mobility, generation, transmission, and/or consumption of energy to transfer power to the mobile server. Without knowledge of the environmental impact, a moving server may receive energy from a mobile energy source that is not environmentally sustainable, resulting in any combination of increased greenhouse gas emissions, accelerated climate change, inefficient energy use, waste of energy resources, and/or an unnecessary strain on the environment.

Some implementations described herein provide determining an optimal mobile computing device for a wireless power transfer. In some aspects, a requesting computing device may transmit an energy transfer request to one or more mobile computing devices. The requesting computing device may indicate information in the energy transfer request, such as an amount of requested energy and/or a location. Based at least in part on transmitting the energy transfer request, the requesting computing device may receive one or more acknowledgment messages from one or more mobile computing device. Each acknowledgment message may be associated with a respective mobile computing device and may include one or more respective operating characteristics of the respective mobile computing device. Some example operating characteristics may include an energy source type, a wireless power transfer method, a travel route and/or a travel length, an energy transfer loss metric, a return energy consumption metric, or a type of power source. The requesting computing device may compute a respective sustainability metric for each mobile computing device using the one or more respective operating characteristics. For example, the requesting computing device may award more points for high sustainability operating conditions relative to low sustainability operating conditions, such as by awarding more points to a renewable energy source relative to a non-renewable energy source. The requesting computing device may select an optimal mobile computing device (e.g., from a group of mobile computing devices that responded with an acknowledgment) using the sustainability metric. In some cases, the requesting computing device may receive an energy transfer from the optimal mobile computing device through a wireless power transmission.

In some aspects, a mobile computing device may receive an energy transfer request from a requesting computing device. The energy transfer request may indicate information, such as an amount of requested energy and/or a location. Based at least in part on receiving the energy transfer request, the mobile computing device may transmit an acknowledgment message to the requesting computing device, and the acknowledgment message may include one or more operating characteristics of the mobile computing device. In some cases, the mobile computing device may receive a selection indication associated with the energy transfer request, and may change from a first location to a second location to be within proximity of the requesting computing device. Based at least in part on receiving the selection indication, the mobile computing device may provide an energy transfer to the requesting computing device through a wireless power transfer system, which may use methods such as inductive coupling, capacitive coupling, or laser-based transmission.

The requesting computing device selecting an optimal mobile computing device using a sustainability metric may mitigate environmental implications of energy management for moving servers, such by the requesting computing device selecting a computing device that reduces carbon emissions associated with mobility, generation, transmission, and consumption of energy. Alternatively, or additionally, selection of an optimal mobile computing device using a sustainability metric may reduce the likelihood of a moving server receiving energy from a mobile energy source that is not environmentally sustainable. Mitigating the environmental implications of energy management for a moving server may reduce the risk of increased greenhouse gas emissions, accelerated climate change, inefficient energy use, waste of energy resources, and unnecessary strain on the environment, resulting in a more sustainable and environmentally friendly solution for energy management in moving servers.

“Sustainability metric” denotes a quantifiable measure used to evaluate the environmental impact and efficiency of a mobile computing device during wireless power transfer. The sustainability metric may be based at least in part on a variety of factors, such as the type of energy source, energy efficiency, carbon emissions, and overall environmental footprint. “Wireless power transfer” denotes a method of transmitting electrical energy from a power source to an electrical load without interconnecting wires. As described herein, a sustainability metric may provide information about an environmental impact of an associated mobile computing device, such as carbon emissions, energy loss, and heat generated during the wireless power transfer process. To illustrate, a first mobile computing device that uses on a renewable energy source and employs efficient transmission methods, such as inductive or capacitive coupling, may generate fewer carbon emissions and experience lower energy loss relative to a second mobile computing device that uses a non-renewable energy source or uses a less efficient energy transfer transmission method. In some cases, a sustainability metric may reflect the various environmental impact factors based at least in part on awarding higher sustainability points to mobile computing devices that minimize carbon emissions, reduce energy loss, and mitigate heat generation as described herein. By incorporating these environmental impact details into the calculation of the sustainability metric, a requesting computing device may ensure a more environmentally friendly and sustainable selection of the optimal mobile computing device for wireless power transfer using a sustainability metric.

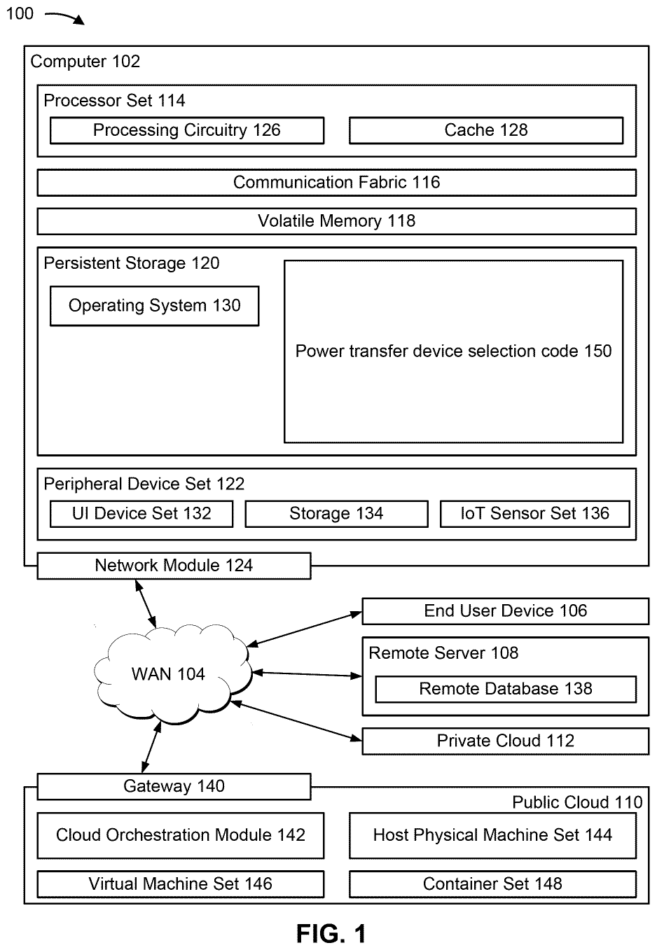

FIG. 1 is a diagram of an example computing environment 100 for determining an optimal mobile computing device for wireless power transfer using a sustainability metric. The computing environment 100 includes an example of an environment that may be used for the execution of at least some of the computer code involved in performing the inventive methods, such as power transfer device selection code 150. In addition to the power transfer device selection code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the power transfer device selection code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in power transfer device selection code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input/output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the power transfer device selection code 150 typically includes at least some of the computer code involved in performing one or more operations described herein. The operations may include, for example, transmitting an energy transfer request; receiving one or more acknowledgment messages from one or more mobile computing devices, each acknowledgment message of the one or more acknowledgment messages being associated with a respective mobile computing device of the one or more mobile computing devices and including one or more respective operating characteristics about the respective mobile computing device; computing a respective sustainability metric for each mobile computing device of the one or more mobile computing devices using the one or more respective operating characteristics of each acknowledgment message; selecting an optimal mobile computing device from the one or more mobile computing devices by analyzing the respective sustainability metric for each mobile computing device of the one or more mobile computing devices; and receiving an energy transfer from the optimal mobile computing device through a wireless power transmission.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

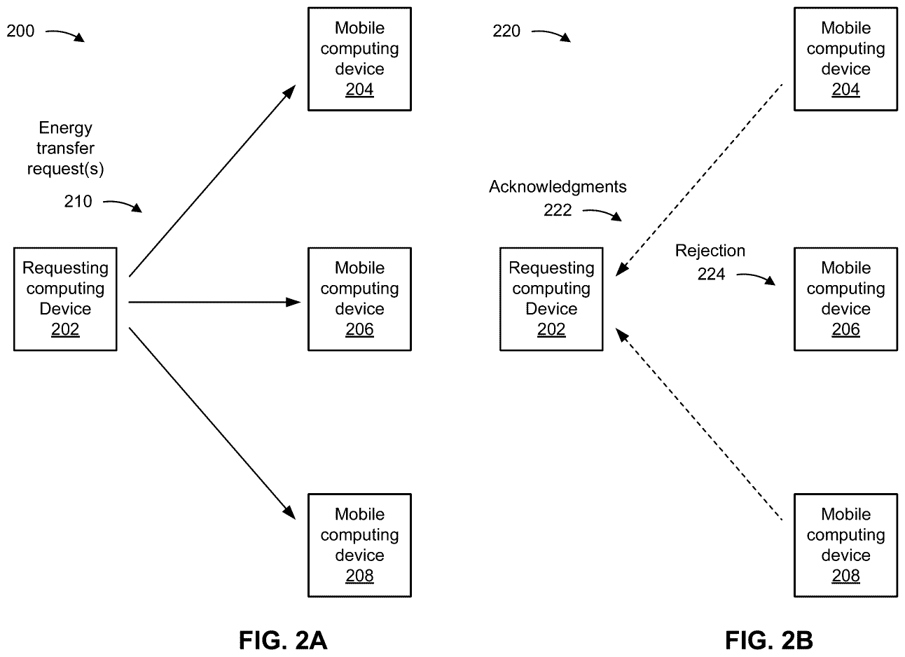

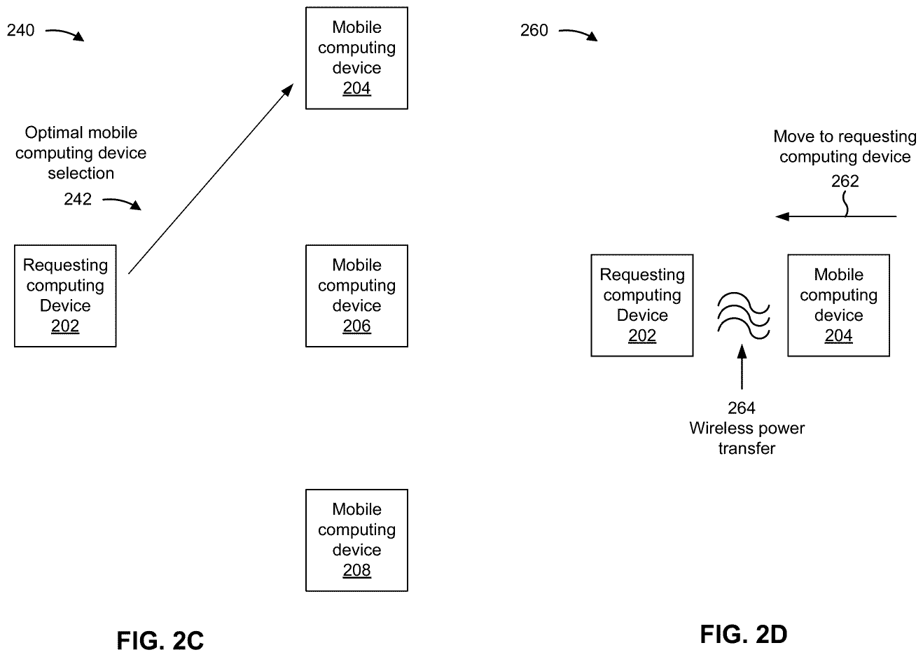

FIGS. 2A, 2B, 2C, and 2D are diagrams of a first example 200, a second example 220, a third example 240, and a fourth example 260, respectively, of communication exchanges that may be used by a requesting computing device to determine an optimal mobile computing device for wireless power transfer using a sustainability metric.

The first example 200 shown by FIG. 2A includes a requesting computing device 202, a first mobile computing device 204, a second mobile computing device 206, and a third mobile computing device 208. In some aspects, the requesting computing device 202 may be a mobile server, such as an autonomous ground vehicle (AGV) or a portable data center housed in a container or specialized vehicle. Examples of mobile computing devices that can provide wireless power transfer include a robotic device equipped with a wireless power transmission system, a mobile data center with built-in wireless power transmission capabilities, or a vehicle-mounted wireless power transmission unit. The requesting computing device 202 may communicate with the first mobile computing device 204, the second mobile computing device 206, and/or the third mobile computing device 208 using one or more wireless communication protocols, such as Bluetooth, Wi-Fi, or cellular networks. Alternatively, or additionally, the requesting computing device 202 may communicate with the first mobile computing device 204, the second mobile computing device 206, and/or the third mobile computing device 208 using one or more wired communication protocols. To illustrate, any combination of the requesting computing device 202, the first mobile computing device 204, the second mobile computing device 206, and/or the third mobile computing device 208 may be docked or connected to a common platform that enables the respective device to communicate using Ethernet, a universal serial bus (USB), or other wired networking protocols.

As shown by FIG. 2A, the requesting computing device 202 may transmit an energy transfer request 210. In some aspects, the requesting computing device 202 may transmit the energy transfer request 210 based at least in part on detecting one or more trigger events or changes in one or more operating conditions that satisfy a predetermined threshold, such as a low battery level trigger event (e.g., a battery level satisfies a low battery threshold) and/or an increase in computational workload trigger event (e.g., an increase by at least a threshold value). Other examples of changes in operational conditions that may trigger the energy transfer request and/or may be considered trigger events include a change in ambient temperature, such as entering a hot or cold climate zone, a change in humidity or air quality, a change in network connectivity or signal strength, a change in motion or velocity, such as accelerating or decelerating, or a change in payload or load requirements.

In some aspects, the requesting computing device 202 may compute an estimated amount of energy used to complete a task, such as by estimating an energy used to process a certain amount of data or to perform a specific computational operation. As one example, the requesting computing device 202 may use historical benchmarking data, such as past energy consumption patterns or performance metrics, to compute the estimated amount of energy. To illustrate, the requesting computing device 202 may leverage historical benchmarking data to estimate an amount of energy used to complete a particular task, such as by referencing historical benchmarking data or past records to determine that collecting 5 gigabytes (GB) of data from IoT devices over a distance of 800 meters historically used 10 volts of energy. The use of historical benchmarking may enable the requesting computing device to perform more accurate energy estimations and ensure that the requesting computing device has sufficient energy to complete assigned tasks.

Based at least in part on determining that a current amount of available energy at the requesting computing device 202 is insufficient to complete the task, the requesting computing device 202 may transmit the energy transfer request 210 as described herein. To illustrate, the requesting computing device 202 may compare the estimated amount of energy with a current amount of available energy at the requesting computing device 202, and, based at least in part on the available energy failing to satisfy the estimated amount of energy, the requesting computing device 202 may initiate the energy transfer request process. By computing an estimated amount of energy used to complete a task and determining whether the current amount of available energy is sufficient, the requesting computing device 202 may mitigate interruptions or failures to perform the task due to energy depletion.

The requesting computing device 202 may communicate the energy transfer request 210 using any type of communication, such as by broadcasting the energy transfer request 210 to all devices within a certain range, multicasting the energy transfer request 210 to a specific group of devices, or unicasting the energy transfer request 210 to a single device. In some cases, the energy transfer request 210 may include information about the request, such as an amount of requested energy, an energy transfer location, and/or one or more requested sustainability characteristics (e.g., a renewable energy source). By including information in the energy transfer request 210, the requesting computing device 202 may increase a probability of receiving energy from a mobile computing device that satisfies an amount of energy and/or sustainability metrics to mitigate an environmental impact of the energy transfer (e.g., by reducing an associated carbon footprint). “Carbon footprint” denotes an amount of greenhouse gases, particularly carbon dioxide, emitted directly or indirectly by an individual, organization, product, or activity over a specific period of time.

As shown by FIG. 2B, one or more mobile computing devices may transmit a respective acknowledgment message 222 to the energy transfer request 210 transmitted by the requesting computing device 202 as described with regard to FIG. 2A. In the second example 220, the first mobile computing device 204 and the third mobile computing device 208 each transmit a respective acknowledgment message 222 to the requesting computing device 202. To illustrate, the first mobile computing device 204 may evaluate information indicated by the energy transfer request 210 against one or more operating conditions at, or operating characteristics of, the first mobile computing device 204, such as a current energy capacity, an energy source, and wireless power transmission methods. Based at least in part on the evaluation, the first mobile computing device 204 may determine that the device is capable of fulfilling the energy transfer request and may transmit an acknowledgment message 222. In a similar manner, the third mobile computing device 208 may evaluate information indicated by the energy transfer request 210 against one or more operating conditions at, or operating characteristics of, the third mobile computing device 208, may determine that the device is capable of fulfilling the energy transfer request, and may transmit an acknowledgment message 222.

In some aspects, the first mobile computing device 204 and/or the third mobile computing device 208 may include information in the respective acknowledgment message 222, such as one or more respective operating characteristics of the device. To illustrate, the acknowledgment may include an energy source type (e.g., solar, wind, or fuel-based), a wireless power transfer method (e.g., inductive coupling, capacitive coupling, or laser-based transmission), a travel route that the device will take to reach the requesting computing device 202, an energy transfer loss metric associated with the wireless power transfer method, a travel energy consumption metric associated with reaching the requesting computing device 202, and/or a return energy consumption metric associated with a return to a base location of the device.

Alternatively, or additionally, a mobile computing device may determine to reject or ignore the energy transfer request. For instance, as shown by reference number 224, the second mobile computing device 206 may reject or ignore the energy transfer request 210. In some cases, the second mobile computing device 206 may explicitly indicate that the energy transfer request is rejected, such as by transmitting a negative acknowledgment or a rejection message to indicate that the device is unavailable to provide the requested energy transfer. The negative acknowledgment or the rejection message may include information that indicates why the second mobile computing device 206 is unable to fulfill the request, such as a lack of available energy or a conflicting priority. The transmission of a rejection message (or negative acknowledgment) may enable the requesting computing device 202 to quickly determine which mobile computing devices are available to provide the requested energy transfer. In other cases, the second mobile computing device 206 may implicitly indicate a rejection by not transmitting a response message, enabling the second mobile computing device 206 to preserve energy resources.

In the third example 240 shown by FIG. 2C, the requesting computing device 202 may select an optimal mobile computing device using the acknowledgments 222 that are received by the requesting computing device 202. That is, the requesting computing device 202 may select the optimal mobile computing device from the mobile computing devices that responded to the energy transfer request 210. As shown by reference number 242, the requesting computing device 202 may transmit a selection indication to the optimal mobile computing device (shown in FIG. 2C as being the first mobile computing device 204).

As one example, based at least in part on multiple mobile computing devices responding to the energy transfer request 210, the requesting computing device 202 may compute a respective sustainability metric for each mobile computing device, and may select the optimal mobile computing device by analyzing the respective sustainability metric(s). The requesting computing device 202 may use respective information in a respective acknowledgment to compute the sustainability metric. To illustrate, the requesting computing device 202 may assign sustainability points to each responding mobile computing device based on the operating characteristic(s) included in each acknowledgment message 222. That is, each operating characteristic may be associated with respective points, and the requesting computing device 202 may tally the points for each operating characteristic (e.g., energy source type, wireless power transfer method, travel route, energy transfer loss metric, and travel energy consumption metric) to compute the sustainability metric for each mobile computing device. A first example of points awarded for an operating characteristic is an energy source type, with renewable energy sources being assigned more sustainability points than non-renewable energy sources. As a second example, sustainability points may be assigned based on the mobile computing device's wireless power transfer method, with more energy efficient methods being assigned more points relative to less energy efficient methods. Alternatively, or additionally, sustainability points may be assigned based on the route taken by the mobile computing device to reach the requesting computing device, with shorter routes being assigned more points. Energy transfer loss metrics and travel energy consumption metrics may also be awarded points, with lower energy transfer loss metrics being assigned more points relative to higher energy transfer loss metrics. By analyzing these sustainability metrics, the requesting computing device 202 may determine which mobile computing device of the responding mobile computing devices is most environmentally friendly and efficient for providing the requested energy transfer. In some aspects, the requesting computing device 202 may evaluate external climate factors, such as temperature, humidity, and weather conditions, that may impact the energy consumption and efficiency of each mobile computing device, and may assign more points for mobile computing devices that are less affected by such factors or have adaptations to mitigate the impact.

Based at least in part on a single mobile computing device responding to the energy transfer request, the requesting computing device 202 may select the single mobile computing device by default. That is, the requesting computing device 202 may select the single mobile computing device without computing a sustainability metric.

In some implementations, the requesting computing device 202 may use a relative or absolute points system to assign sustainability points to each operating characteristic. To illustrate, in an absolute points system, a fixed number of points may be assigned to each operating characteristic based on its value or category, such as 10 points for a renewable energy source or 8 points for an efficient wireless power transfer method. In a relative points system, points may be assigned based on the relative value or ranking of each option, such as 10 points for the most renewable energy source or the most efficient wireless power transfer method, and 8 points for the second-best option. Using either a relative points system or an absolute points system, the requesting computing device 202 may assign more points for a renewable energy source, more points for a more efficient wireless power transfer method, more points for a shorter travel route, more points for a lower energy transfer loss metric, or more points for a lower travel energy consumption metric. The requesting computing device 202 may then select the mobile computing device (e.g., from the responding mobile computing devices) with the highest total points, and thus the highest sustainability metric, as the optimal mobile computing device. In a scenario in which multiple mobile computing devices may be used to provide the requested amount of energy, the requesting computing device 202 may select multiple mobile computing devices based on their respective sustainability metrics and prioritize energy transfer from the mobile computing device with the highest sustainability metric.

In some aspects, the requesting computing device 202 may use a combination of a relative points system and an absolute points system to assign sustainability points to each operating characteristic, such that the points assigned to each characteristic are determined by both a relative ranking of the characteristic and an absolute value associated with the characteristic. A hybrid approach may enable a more accurate assessment of the sustainability of each mobile computing device (e.g., relative to using only a relative points system or only an absolute points system) by considering multiple factors and perspectives.

The requesting computing device 202 may use a formula to calculate the sustainability metric for each mobile computing device. For example, the requesting computing device 202 may use a formula as follows:

Sustainability metric=carbon intensity (the base station grid)×[P(IT)+P(non-IT)],

where carbon intensity is the amount of carbon emissions per unit of energy consumed, P(IT) is a power consumption of information technology (IT) equipment (e.g., a mobile computing device's processor and memory), and P(non-IT) is the power consumption of non-IT equipment (e.g., the mobile computing device's cooling system and power supply). Using the above formula may enable the requesting computing device 202 to calculate a sustainability metric that is based at least in part on carbon emissions that are associated with energy consumption of each mobile computing device, as well as power consumption of both the IT and non-IT equipment, resulting in a more comprehensive and accurate assessment of the sustainability of each mobile computing device.

Based at least in part on selecting the optimal mobile computing device, the requesting computing device 202 may send a selection indication to the selected mobile computing device as described above. The selection indication may include information associated with an energy transfer, such as any combination of an identifier of the selected mobile computing device, an amount of energy to be transferred, a location and/or time of the energy transfer, or a wireless power transfer method to be used. Including information associated with the energy transfer in the selection indication may enable the selected mobile computing device to proceed with the energy transfer according to the specified details.

In some aspects, the requesting computing device 202 may track carbon credits earned as a result of prioritizing mobile computing devices with lower carbon footprints (e.g., using the sustainability metric). As one example, the requesting computing device 202 may determine a number of carbon credits earned based on a difference between a carbon footprint of the selected mobile computing device and a carbon footprint of a baseline or average mobile computing device. The requesting computing device 202 may track or tabulate the earned carbon credits in a database or a ledger, such as by incrementing a counter or a balance associated with the carbon credits (e.g., “10 carbon credits earned for selecting the first mobile computing device 204, which uses solar power and has an energy consumption metric of 5 kilowatt hours”). The requesting computing device 202 may transmit a report or a tally of the earned carbon credits to a carbon credit authority or a regulatory agency (e.g., by way of an operator), and may receive carbon credits from the authority or agency, such as in the form of a digital certificate or a credit balance in a carbon credit registry.

In the fourth example 260 shown by FIG. 2D, the mobile computing device that received the selection indication (e.g., shown by FIG. 2D as being the first mobile computing device 204) may move to the requesting device as shown by reference number 262. For example, the first mobile computing device 204 may move to a location that is specified in the selection indication and/or may use a route specified in the selection indication to move to the requesting computing device. Based at least in part on reaching the requesting computing device 202 (e.g., to a location within proximity of the requesting computing device 202 and/or a proximity associated with a successful wireless power transfer with the requesting computing device), the first mobile computing device 204 may perform a wireless power transfer as shown by reference number 264. In some cases, the selected mobile computing device may perform the wireless power transfer using a method specified by the selection indication, such as inductive coupling, capacitive coupling, or laser-based transmission. The selected mobile computing device may use information from the selection indication to optimize the wireless power transfer, such as adjusting the power level or transmission frequency to achieve efficient energy transfer. By performing the wireless power transfer, the first mobile computing device 204 may provide energy to the requesting computing device 202, enabling the device to continue operating or to complete a task.

As an example, a wireless power transfer system may utilize an inductive coupling method that creates an electromagnetic field through coils to transfer energy. To illustrate, a primary coil, located in a mobile computing device, may generate an alternating magnetic field when an alternating current (AC) flows through the primary coil. A secondary coil, located in a requesting computing device, may be placed within the magnetic field, inducing a current in the secondary coil which can then be converted back to direct current (DC) to charge a battery of the requesting computing device. An efficiency of an inductive coupling method may be influenced by a distance between the primary coil and the secondary coil, an alignment of the primary coil and the secondary coil, and/or a frequency of the AC current.

Based at least in part on the requesting computing device 202 requesting multiple mobile computing devices to provide an energy transfer, each selected mobile computing device may move to the requesting computing device 202 and perform a wireless power transfer. In some aspects, the requesting computing device 202 may coordinate the energy transfer from each device to ensure efficient and effective energy delivery. As one example, the requesting computing device 202 may prioritize the energy transfer from each mobile computing device based at least in part on the respective sustainability metrics, such as by receiving a larger portion of the energy transfer (e.g., 80%) from a renewable energy source and a smaller portion of the energy transfer (e.g., 20%) from a non-renewable energy source. As a second example, the requesting computing device 202 may coordinate the energy transfer from each mobile computing device by scheduling the energy transfer in a sequence that optimizes the overall energy efficiency, such as by receiving energy from a device with a high sustainability metric during a first period of high energy demand and receiving energy from a device with a lower sustainability metric during a second period of low energy demand.

FIGS. 2A, 2B, 2C, and 2D are provided as examples. Other examples may differ from what is described with regard to FIGS. 2A, 2B, 2C, and 2D.

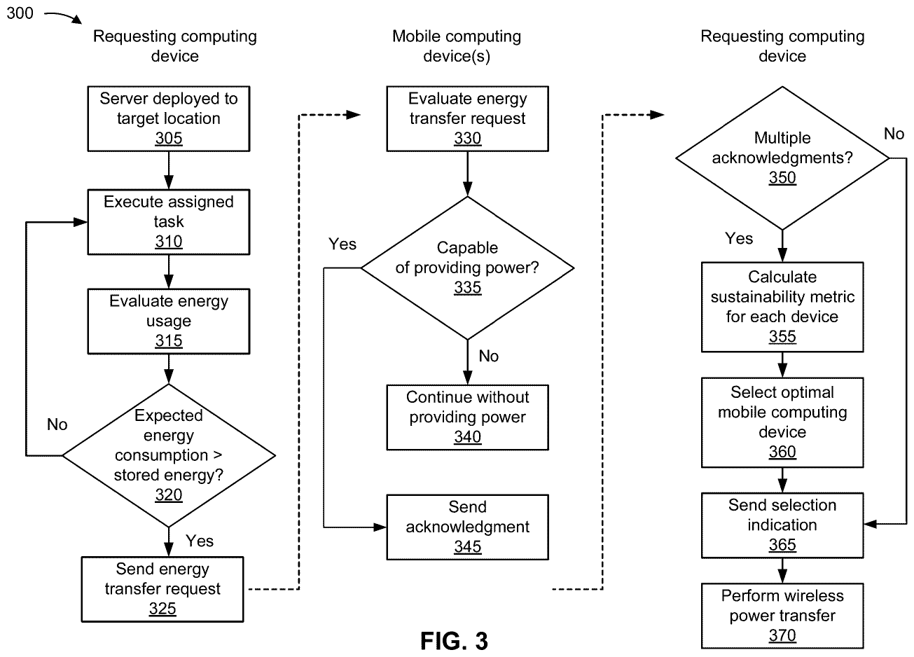

FIG. 3 is an example flow diagram 300 for a process that may be used to determine an optimal mobile computing device for wireless power transfer using a sustainability metric. The process described with regard to the flow diagram 300 includes at least some steps that may be performed by a requesting computing device (e.g., the requesting computing device 202) and at least some steps that may be performed by a mobile computing device (e.g., the first mobile computing device 204, the second mobile computing device 206, and/or the third mobile computing device 208). Steps in the process that may be performed by a requesting computing device are located in FIG. 3 under a label “Requesting computing device” and steps in the process that may be performed by a mobile computing are located in FIG. 3 under a label “Mobile computing device(s).”

The process may begin at step 305 in which a requesting computing device (e.g., a mobile server) is deployed to a target location as described with regard to FIG. 2A. To illustrate, the requesting computing device may be an AGV that is equipped with mobile edge computing (MEC) capabilities. In some cases, the requesting computing device may be deployed to remote locations to collect and process data generated by IoT devices, provide computing resources to users in areas with limited connectivity, or support various applications in dynamic environments

At step 310, the process may include executing an assigned task, such as collecting and processing data generated by IoT devices or providing computing resources to users in remote or disaster-stricken areas. For example, as a mobile server, a requesting computing device performing the process may process data from sensors or cameras in real-time, providing insights or recommendations to users. Alternatively, the requesting computing device may provide computing resources, such as processing power or storage capacity, to users in areas with limited connectivity. The process may include receiving an assigned task from a remote server (e.g., the remove server 108) or through a pre-programmed schedule, which includes information about the task, such as data to be collected, processing operating conditions, and deadlines. Alternatively, or additionally, the process may include receiving user input (e.g., through a control panel or a mobile app) that manually assigns a task to the requesting computing device.

At step 315, the process may include evaluating an energy usage and/or an expected energy consumption. To illustrate, as described with regard to FIG. 2A, a requesting computing device may compute, as the expected energy consumption, an expected amount of energy that may be used to perform a task, such as by using historical benchmarking data and/or real-time energy usage patterns. As an example, the requesting computing device may compute an expected amount of energy that may be used to collect and process data generated by one or more IoT devices, to process data from sensors or cameras, or to provide computing resources to users in areas with limited connectivity.

At step 320, the process may include evaluating the expected energy consumption with an amount of stored energy. To illustrate, as described with regard to FIG. 2A, a requesting computing device may compare the expected energy consumption, computed at step 315, with a current battery level or available energy stored in the requesting computing device. For example, the requesting computing device may determine whether the current battery level is sufficient to provide the expected amount of energy required to perform a task (e.g., collecting and processing or providing computing resources). Based at least in part on determining that the amount of stored energy is sufficient for providing the expected amount of energy, the process may continue as shown by the “No” path to step 310 that includes executing the task. For instance, the requesting computing device may continue to perform a task without requesting additional energy, and/or using the stored energy to complete the task. The process may include periodically checking, at predetermined intervals or in response to trigger events, to determine if the requesting computing device has sufficient energy to continue performing tasks or if additional energy is required.

Based at least in part on determining that the amount of stored energy is insufficient for providing the expected amount of energy, the process may continue as shown by the “Yes” path to step 325. To illustrate, as described with regard to FIG. 2A, a requesting computing device may determine that a current battery level or available energy at the requesting computing device is insufficient to perform a task. For example, the requesting computing device may detect a low battery level or an increase in computational workload that requires additional energy to complete the task. At step 325, the requesting computing device may send an energy transfer request to one or more mobile computing devices. Alternatively, or additionally, the energy transfer request may include information about the task, such as the expected amount of energy required, a requested type of energy, and/or a location for the energy transfer.

As shown by FIG. 3 through the use of a first dotted line, the energy transfer request may be received by one or more mobile computing device(s). The energy transfer request may include information such as the amount of energy required, the location of the requesting computing device, and the preferred method of wireless power transfer.

At step 330, the process may include evaluating the energy transfer request. To illustrate, as described with regard to FIG. 2B, a mobile computing device may receive the energy transfer request, such as through a broadcast message, unicast message, or multicast message, from a requesting computing device. In some aspects, the mobile computing device may evaluate the energy transfer request against current operating conditions at the mobile computing device, such as an available amount of energy, transmission capabilities, and/or an environmental impact associated with performing the energy transfer. For example, the mobile computing device may compare requested power transfer characteristics, such as a requested amount of energy, a preferred method of wireless power transfer, and/or a desired location for the energy transfer, indicated in the energy transfer request, with capabilities and characteristics of the mobile computing device.

At step 335, the process may include evaluating whether the mobile computing device is capable of providing power and/or satisfying an energy transfer request. To illustrate, as described with regard to FIG. 2B, the mobile computing device may consider factors such as a current task workload, energy usage patterns, and/or power source in evaluating the energy transfer request. For example, a mobile computing device may assess current operating conditions to determine whether the mobile computing device is capable of fulfilling the energy transfer request in a manner that is consistent with information indicated in the energy transfer request, such as a requested amount of energy, a preferred method of wireless power transfer, a desired location for the energy transfer, and/or a specified timeframe for the energy transfer.

Based at least in part on determining that the mobile computing device is not capable of providing power as requested via the energy transfer request, the process may proceed as shown by the “No” path to step 340. To illustrate, as described with regard to FIG. 2B, the mobile computing device may reject the energy transfer request or ignore the request without responding, in which case the process continues without the mobile computing device providing power. For example, the mobile computing device may transmit a rejection message or a negative acknowledgment to indicate that the energy transfer request cannot be fulfilled by the mobile computing device, or may simply not respond to the energy transfer request, allowing the requesting computing device to select an alternative mobile computing device for energy transfer.

Based at least in part on determining that an amount of stored energy at the mobile computing device is sufficient for satisfying the energy transfer request, the process may proceed as shown by the “Yes” path to step 345. To illustrate, as described with regard to FIG. 2B, the mobile computing device may send an acknowledgment to the requesting computing device, indicating that the energy transfer request can be fulfilled by the mobile computing device. In some aspects, the acknowledgment may include information such as an energy source type of the mobile computing device (e.g., renewable or non-renewable), a transmission method for the power transfer (e.g., inductive coupling, capacitive coupling, or laser-based transmission), and/or environmental impact (e.g., carbon emissions or heat generated). Alternatively, or additionally, the acknowledgment may include other information, such as a travel route or travel length to reach the requesting computing device, an energy transfer loss metric, and/or a return energy consumption metric.

As shown in FIG. 3 through the use of a second dotted line, an acknowledgment may be received by the requesting computing device. To illustrate, as described with regard to FIG. 2B, the requesting computing device may receive one or more acknowledgments from one or more mobile computing devices. At step 350, the process may include evaluating whether multiple acknowledgments have been received, such as evaluating whether acknowledgments have been received from multiple mobile computing devices in response to an energy transfer request. Based at least in part on determining that (only) a single acknowledgment was received, the process may proceed as shown by the “No” path to step 365, which is described below. Based at least in part on determining that multiple acknowledgments were received, the process may proceed as shown by the “Yes” path to step 355.

At step 355, the process may include calculating a sustainability metric for each responding mobile computing device. To illustrate, as described with regard to FIG. 2C, a requesting computing device may assess various factors associated with each mobile computing device, such as energy source (e.g., renewable or non-renewable), transmission method (e.g., inductive coupling, capacitive coupling, or laser-based transmission), environmental impact (e.g., carbon emissions or heat generated), distance to be traveled to reach the requesting computing device, and energy loss during transmission. Calculating the sustainability metric may include assigning sustainability points to each mobile computing device, such as by assigning more points to devices using renewable energy sources, efficient transmission methods, and having lower environmental more points relative to devices that use non-renewable energy sources, less efficient transmission methods, and have higher environmental impact. The process may include comparing and/or ranking the mobile computing devices using the sustainability metric, thus enabling a device (e.g., the requesting computing device) to select an optimal mobile computing device (e.g., out of a group of mobile computing devices) that minimizes environmental impact.

At step 360, the process may include selecting an optimal mobile computing device from the responding mobile computing devices (e.g., a relative optimal mobile computing device). To illustrate, as described with regard to FIG. 2C, the requesting computing device may evaluate the sustainability metrics calculated for each responding mobile computing device and select the device with the highest sustainability metric. As one example, the requesting computing device may compare the sustainability metrics of each mobile computing device and may select, as the optimal mobile computing device, the mobile computing device in the group that has the lowest environmental impact, uses the most renewable energy source, and/or has the most efficient transmission method.

At step 365, the process may include sending a selection indication to the optimal mobile computing device. To illustrate, as described with regard to FIG. 2C, the requesting computing device may transmit a selection indication that includes information such as an identifier of the selected mobile computing device, an amount of energy to be transferred, a location and/or time of the energy transfer, and/or a wireless power transfer method to be used (e.g., inductive coupling, capacitive coupling, or laser-based transmission). In some aspects, the selection indication may specify a power level or transmission frequency to be used for the energy transfer, or a travel route.

At step 370, the process may include performing a wireless power transfer. To illustrate, as described with regard to FIG. 2D, the selected mobile computing device may change locations to operate within proximity of the requested computing device to enable a wireless power transfer to the requesting computing device. As at least part of performing the wireless power transfer, the requesting computing device may coordinate with the selected mobile computing device to optimize the energy transfer process, such as by adjusting a power level or transmission frequency at the requesting computing device to match the selected mobile computing device. The selected mobile computing device may transmit, and the requesting computing device may receive, the energy.

Alternatively, or additionally, the process described with regard to FIG. 3 may include various actions that ensure a successful energy transfer and to maintain records of the transfer. These actions may include, for example, monitoring the energy transfer, such as by the requesting computing device tracking the amount of energy received, the energy transfer rate, and any errors or issues that may occur during the energy transfer. The requesting computing device may also send a confirmation to the selected mobile computing device, indicating that the energy transfer was successful and providing information such as the amount of energy received and any errors or issues that occurred during the energy transfer. In some aspects, the selected mobile computing device may update an energy status of the device, such as by updating an amount of available energy, transmission capabilities, and environmental impact based on the energy transfer, to ensure accurate and up-to-date records.

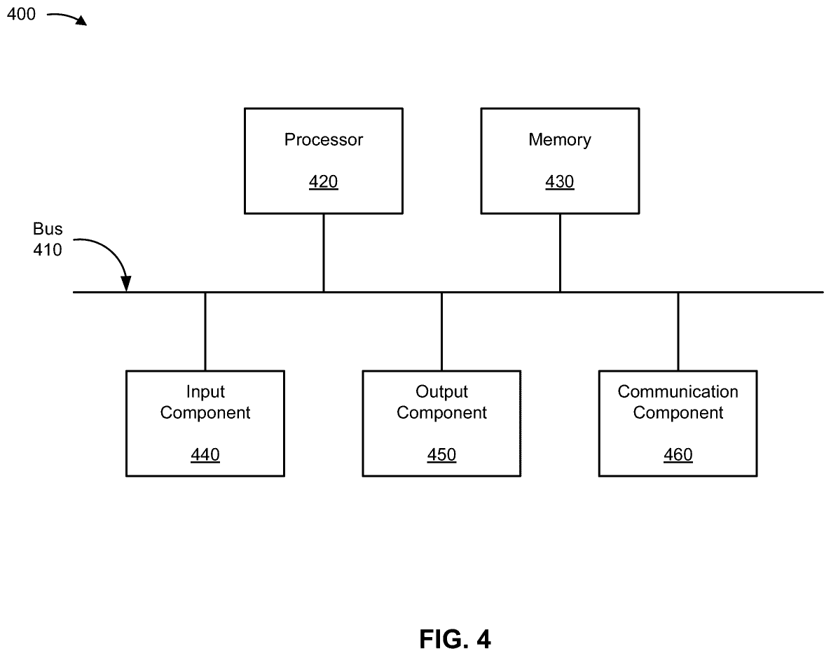

FIG. 4 is a diagram of example components of a device 400 associated with determining an optimal mobile computing device for wireless power transfer using a sustainability metric. The device 400 corresponds to one or more of a requesting computing device (e.g., the requesting computing device 202) or a mobile computing device (e.g., the first mobile computing device 204, the second mobile computing device 206, and/or the third mobile computing device 208). In some implementations, a requesting computing device or a mobile computing device includes one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

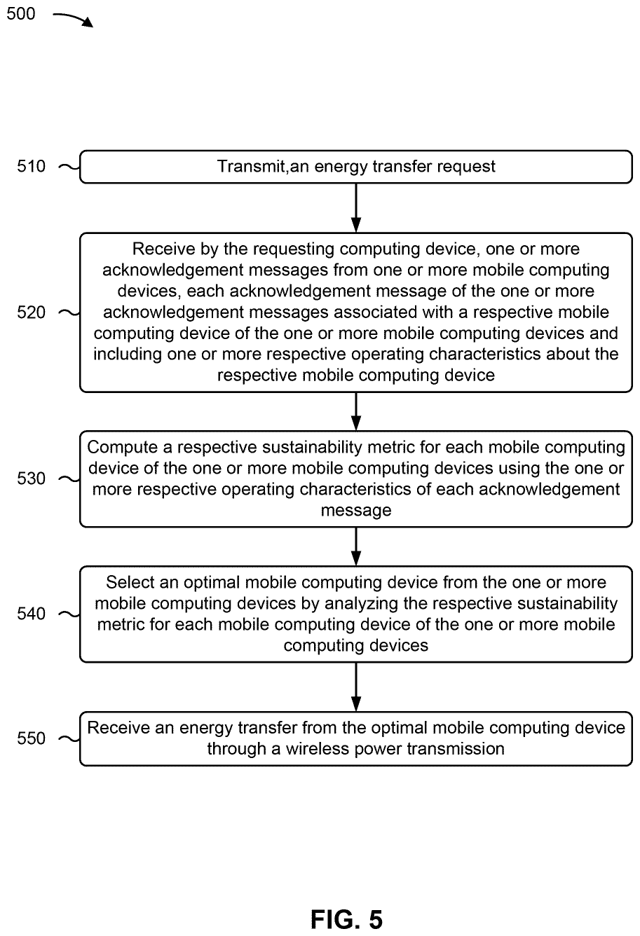

FIG. 5 is a flowchart of an example process 500 associated with determining an optimal mobile computing device for wireless power transfer using a sustainability metric. One or more process blocks of FIG. 5 are performed by a requesting computing device (e.g., requesting computing device 202) and/or by another device or a group of devices separate from or including the requesting computing device, such as a mobile computing device (the first mobile computing device 204, the second mobile computing device 206, and/or the third mobile computing device 208). Additionally, or alternatively, one or more process blocks of FIG. 5 may be performed by one or more components of device 400, such as processor 420, memory 430, input component 440, output component 450, and/or communication component 460.

As shown in FIG. 5, process 500 includes transmitting an energy transfer request (block 510). For example, the requesting computing device may transmit an energy transfer request, as described above.

As further shown in FIG. 5, process 500 includes receiving one or more acknowledgment messages from one or more mobile computing devices, each acknowledgment message of the one or more acknowledgment messages associated with a respective mobile computing device of the one or more mobile computing devices and including one or more respective operating characteristics about the respective mobile computing device (block 520). For example, the requesting computing device may receive a single acknowledgment message from a single mobile computing device, or multiple acknowledgment messages from multiple mobile computing devices (e.g., a respective acknowledgment message from each mobile computing device of the multiple mobile computing devices). Each acknowledgment message of the one or more acknowledgment messages may be with a respective mobile computing device of the one or more mobile computing devices and include one or more respective operating characteristics about the respective mobile computing device, as described above.

As further shown in FIG. 5, process 500 includes computing a respective sustainability metric for each mobile computing device of the one or more mobile computing devices using the one or more respective operating characteristics of each acknowledgment message (block 530). For example, the requesting computing device may compute a respective sustainability metric for each mobile computing device of the one or more mobile computing devices using the one or more respective operating characteristics of each acknowledgment message, as described above.

As further shown in FIG. 5, process 500 includes selecting an optimal mobile computing device from the one or more mobile computing devices by analyzing the respective sustainability metric for each mobile computing device of the one or more mobile computing devices (block 540). For example, the requesting computing device may select an optimal mobile computing device from the one or more mobile computing devices by analyzing the respective sustainability metric for each mobile computing device of the one or more mobile computing devices, as described above.

As further shown in FIG. 5, process 500 includes receiving an energy transfer from the optimal mobile computing device through a wireless power transmission (block 550). For example, the requesting computing device may receive an energy transfer from the optimal mobile computing device through a wireless power transmission, as described above.

Process 500 may include additional aspects, such as any single aspect or any combination of aspects described below and/or in connection with one or more other processes described elsewhere herein.

In a first aspect, the one or more respective operating characteristics comprise at least one of an energy source type, a wireless power transfer method, a travel route, an energy transfer loss metric associated with the wireless power transfer method, a travel energy consumption metric associated with reaching the requesting computing device, or a return energy consumption metric associated with a return to a base location.

In a second aspect, computing the respective sustainability metric for each mobile computing device comprises assigning one or more points to each mobile computing device based at least in part on the respective operating characteristics of the mobile computing device.

In a third aspect, the one or more points are based on a relative system in which an assigned point is dynamically computed.

In a fourth aspect, the one or more points are based on an absolute system that uses one or more preconfigured point values.

In a fifth aspect, the respective sustainability metric of the optimal mobile computing device indicates that the optimal mobile computing device has a least amount of environmental impact of the one or more mobile computing devices.

In a sixth aspect, transmitting the energy transfer requests comprises broadcasting the energy transfer request.

In a seventh aspect, process 500 includes computing an estimated amount of energy used to complete a task, and determining that a current amount of available energy is insufficient to complete the task, wherein transmitting the energy transfer request is based at least in part on determining that the current amount of available energy is insufficient.

In an eighth aspect, computing the estimated amount of energy is based at least in part on historical benchmarking data.

In a ninth aspect, the energy transfer request comprises at least one of a requested amount of energy, a location for an energy transfer, or a time deadline for receiving the energy transfer.

In a tenth aspect, the one or more mobile computing devices comprises a set of mobile computing devices, and selecting the optimal mobile computing device comprises selecting the optimal mobile computing device based at least in part on prioritizing, for the energy transfer, mobile computing devices in the set of mobile computing devices with lower carbon footprints over mobile computing devices in the set of mobile computing devices with higher carbon footprints.

In an eleventh aspect, process 500 includes tracking one or more carbon credits that are earned as a result of prioritizing, for the energy transfer, mobile computing devices in the set of mobile computing devices with lower carbon footprints over mobile computing devices in the set of mobile computing devices with higher carbon footprints.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

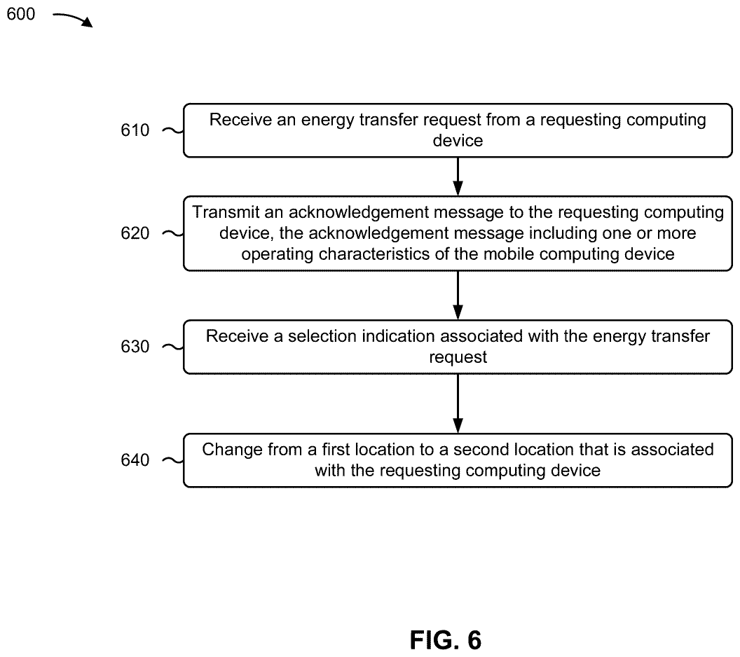

FIG. 6 is a flowchart of an example process 600 associated with determining an optimal mobile computing device for wireless power transfer using a sustainability metric. One or more process blocks of FIG. 6 are performed by a mobile computing device (e.g., the first mobile computing device 204, the second mobile computing device 206, and/or the third mobile computing device 208) and/or by another device or a group of devices separate from or including the mobile computing device, such as a requesting computing device (e.g., requesting computing device 202). Additionally, or alternatively, one or more process blocks of FIG. 6 may be performed by one or more components of device 400, such as processor 420, memory 430, input component 440, output component 450, and/or communication component 460.

As shown in FIG. 6, process 600 includes receiving an energy transfer request from a requesting computing device (block 610). For example, the mobile computing device may receive an energy transfer request from a requesting computing device, as described above.

As further shown in FIG. 6, process 600 includes transmitting an acknowledgment message to the requesting computing device, the acknowledgment message including one or more operating characteristics of the mobile computing device (block 620). For example, the mobile computing device may transmit an acknowledgment message to the requesting computing device, the acknowledgment message including one or more operating characteristics of the mobile computing device, as described above.

As further shown in FIG. 6, process 600 includes receiving a selection indication associated with the energy transfer request (block 630). For example, the mobile computing device may receive a selection indication associated with the energy transfer request, as described above.

As further shown in FIG. 6, process 600 includes changing from a first location to a second location that is associated with the requesting computing device (block 640). For example, the mobile computing device may change from a first location to a second location that is associated with the requesting computing device, as described above.

Process 600 may include additional aspects, such as any single aspect or any combination of aspects described below and/or in connection with one or more other processes described elsewhere herein.

In a first aspect, process 600 includes providing an energy transfer to the requesting computing device through a wireless power transfer system.

In a second aspect, the wireless power transfer system uses at least one of inductive coupling, capacitive coupling, or laser-based transmission.

In a third aspect, the one or more operating characteristics include at least one of an energy source type, a wireless power transfer method, a travel route, an energy transfer loss metric associated with the wireless power transfer method, a travel energy consumption metric associated with reaching the requesting computing device, or a return energy consumption metric associated with a return to a base location.

In a fourth aspect, process 600 includes computing an available energy capacity based at least in part on the energy transfer request, wherein transmitting the acknowledgment message is based at least in part on the available energy capacity satisfying an energy threshold that is associated with the energy transfer request.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (an erasable programmable read-only memory (EPROM) or Flash memory), static random accesnon-ITs memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer-implemented method comprising:
transmitting, by a requesting computing device, an energy transfer request;
receiving, by the requesting computing device, one or more acknowledgment messages from one or more mobile computing devices, each respective acknowledgment message of the one or more acknowledgment messages being associated with a respective mobile computing device of the one or more mobile computing devices, the respective acknowledgment message including one or more respective operating characteristics of the respective mobile computing device;
computing, by the requesting computing device, a respective sustainability metric for each mobile computing device of the one or more mobile computing devices using the one or more respective operating characteristics of each acknowledgment message;
selecting, by the requesting computing device, an optimal mobile computing device from the one or more mobile computing devices by analyzing the respective sustainability metric for each mobile computing device of the one or more mobile computing devices; and
receiving, by the requesting computing device, an energy transfer from the optimal mobile computing device through a wireless power transmission.

2. The computer-implemented method of claim 1, wherein the one or more respective operating characteristics of each mobile computing device of the one or more mobile computing devices comprise at least one of:
an energy source type,
a wireless power transfer method,
a travel route,
an energy transfer loss metric associated with the wireless power transfer method,
a travel energy consumption metric associated with reaching the requesting computing device, or
a return energy consumption metric associated with a return to a base location.

3. The computer-implemented method of claim 1, wherein computing the respective sustainability metric for each mobile computing device comprises:
assigning one or more points to each mobile computing device based at least in part on the respective operating characteristics of the mobile computing device.

4. The computer-implemented method of claim 3, wherein the one or more points are based on a relative system in which an assigned point is dynamically computed.

5. The computer-implemented method of claim 3, wherein the one or more points are based on an absolute system that uses one or more preconfigured point values.

6. The computer-implemented method of claim 1, wherein the respective sustainability metric of the optimal mobile computing device indicates that the optimal mobile computing device has a least amount of environmental impact of the one or mobile computing devices.

7. The computer-implemented method of claim 1, wherein transmitting the energy transfer request comprises:
broadcasting the energy transfer request.

8. The computer-implemented method of claim 1, further comprising:
computing an estimated amount of energy used to complete a task; and
determining that a current amount of available energy is insufficient to complete the task,
wherein transmitting the energy transfer request is based at least in part on determining that the current amount of the available energy is insufficient.

9. The computer-implemented method of claim 8, wherein computing the estimated amount of energy is based at least in part on historical benchmarking data.

10. The computer-implemented method of claim 1, wherein the energy transfer request comprises at least one of:
a requested amount of energy,
a location for an energy transfer, or
a time deadline for receiving the energy transfer.

11. The computer-implemented method of claim 1, wherein the one or more mobile computing devices comprises a set of mobile computing devices, and
wherein selecting the optimal mobile computing device comprises:
selecting the optimal mobile computing device based at least in part on prioritizing, for the energy transfer, mobile computing devices in the set of mobile computing devices with lower carbon footprints over mobile computing devices in the set of mobile computing devices with higher carbon footprints.

12. The computer-implemented method of claim 11, further comprising:
tracking one or more carbon credits that are earned as a result of prioritizing, for the energy transfer, mobile computing devices in the set of mobile computing devices with lower carbon footprints over mobile computing devices in the set of mobile computing devices with higher carbon footprints.

13. A computer system comprising:
a processor set;
one or more computer-readable storage media; and
program instructions stored on the one or more computer-readable storage media to cause the processor set to perform operations comprising:
broadcasting an energy transfer request based at least in part on a trigger event;
receiving one or more acknowledgment messages to the energy transfer request, each respective acknowledgment message of the one or more acknowledgment messages including one or more respective operating characteristics of a respective mobile computing device;
selecting, to perform an energy transfer, an optimal mobile computing based at least in part on the one or more acknowledgment messages;
transmitting a selection indication that specifies the optimal mobile computing device is selected to perform the energy transfer; and
receiving the energy transfer from the optimal mobile computing device through a wireless power transmission.

14. The computer system of claim 13, wherein the program instructions to cause the processor set to perform selecting the optimal mobile computing device are further configured to cause the processor set to perform operations comprising:
computing a respective sustainability metric for the respective mobile computing device by assigning one or more points to the respective mobile computing device based at least in part on the respective operating characteristics.

15. The computer system of claim 13, wherein the program instructions are further configured to cause the processor set to perform operations comprising:
computing an estimated amount of energy used to complete a task; and
determining that a current amount of available energy is insufficient to complete the task,
wherein transmitting an energy transfer request is based at least in part on determining that the current amount of the available energy is insufficient.

16. A computer program product comprising:
one or more computer-readable storage media; and
program instructions stored on the one or more computer-readable storage media to cause a processor set to perform operations comprising:
transmitting an energy transfer request to mobile computing devices;
receiving multiple acknowledgment messages from multiple mobile computing devices, each acknowledgment message being associated with a respective mobile computing device of the multiple mobile computing devices, each acknowledgment message including one or more operating characteristics about the respective mobile computing device;
computing, a respective sustainability metric for each mobile computing device of the multiple mobile computing devices using the one or more operating characteristics of the respective acknowledgment message;
transmitting a selection indication to one or more mobile computing devices of the multiple mobile computing devices based at least in part on the respective sustainability metric for each mobile computing device of the one or more mobile computing devices; and
coordinating an energy transfer from one or more mobile computing devices.

17. The computer program product of claim 16, wherein the one or more operating characteristics comprise at least one of:
an energy source type,
a method for wireless power transmission,
a travel route,
an energy loss metric associated with the wireless power transmission,
a travel energy consumption metric associated with reaching a requesting computing device, or
a return energy consumption metric associated with returning to a base location.

18. The computer program product of claim 16, wherein the program instructions to cause the processor set to perform computing the respective sustainability metric are further configured to cause the processor set to perform operations comprising:
assigning, as at least part of the respective sustainability metric, one or more sustainability points to the respective mobile computing device of the multiple mobile computing devices based on the one or more operating characteristics in the respective acknowledgment message.

19. The computer program product of claim 16, wherein the program are configured to cause the processor set to perform operations comprising:
computing an estimated amount of energy used to complete a task; and
determining that a current amount of available energy is insufficient to complete the task,
wherein transmitting the energy transfer request is based on determining that the current amount of the available energy is insufficient.

20. The computer program product of claim 16, wherein the energy transfer request comprises at least one of:
a requested amount of energy,
a location for an energy transfer, or
a time deadline for receiving the energy transfer.
